(19) United States
(12) Patent Application Publication
(10) Pub. No.: US 2023/0339154 A1
(43) Pub. Date: Oct. 26, 2023

(54) METHOD FOR MANUFACTURING FOAM MAT HAVING PRINTED LAYER ON ITS SURFACE

(71) Applicant: CHI-CHEN KAO, Nantou City (TW)

(72) Inventor: CHI-CHEN KAO, Nantou City (TW)

(21) Appl. No.: 17/660,037

(22) Filed: Apr. 21, 2022

(51) Int. Cl. B29C 44/34; B29C 44/12

(52) U.S. Cl. CPC B29C 44/34; B29C 44/1285; B29C 2795/002; B29K 2021/00

(57) ABSTRACT

A method for manufacturing a foam mat having a printed layer on its surface includes the steps of: stacking a plurality of foam sheets in a foaming mold; forming a printed layer by printing a layer of ink on a top surface of an uppermost one of the foam sheets or a bottom surface of a lowermost one of the foam sheets or both; and heating the mold for foaming the foam sheets at a same foaming rate of 2 to 3.5 times. The ink of the printed layer does not fall off. The printed layer can beautify the surface of the foam mat and prevent dust and dirt from accumulating on the surface of the foam mat.

### FIELD OF THE INVENTION

The present invention relates to a foam mat, and more particularly to a method for manufacturing a foam mat having a printed layer on its surface.

### BACKGROUND OF THE INVENTION

Mats made from recycled rubber materials are widely used in our daily life. In general, patterns or figures are printed on the surfaces of the mats for decoration. The color of the recycled material is usually black. The cost of adding pigments to change the color is extremely high. Colors or patterns are printed on the surfaces of the finished mats to decorate the mats. However, there is an oil film on the surface of the recycled material. As a result, the printed color is difficult to adhere to the mat, and it is easy to fall off in actual use. In addition, the mat made from recycled materials is cumbersome and has poor elasticity. The surface of the mat has many pores. Dust or dirt accumulates on the surface of the mat easily, leading to a risk of health hazard.

### SUMMARY OF THE INVENTION

The primary object of the present invention is to provide a method for manufacturing a foam mat having a printed layer on its surface. The ink of the printed layer does not fall off. The printed layer can beautify the surface of the foam mat and prevent dust and dirt from accumulating on the surface of the foam mat.

In order to achieve the object, the method comprises the steps of: stacking a plurality of foam sheets in a foaming mold; forming a printed layer by printing a layer of ink on a top surface of an uppermost one of the foam sheets or a bottom surface of a lowermost one of the foam sheets or both; and heating the mold for foaming the foam sheets at a same foaming rate of 2 to 3.5 times.

Preferably, the foam sheets are made of rubber or a mixed material mainly consisting of rubber.

Preferably, the printed layer has a single color or a pattern.

Preferably, the foam sheets have a color similar to that of the printed layer.

Embodiments of the present invention will now be described, by way of example only, with reference to the accompanying drawings.

### BRIEF DESCRIPTION OF THE DRAWINGS

FIG. 1 is a flow chart of the present invention;

FIG. 2 is schematic view of the foam sheets before foaming according to the method of the present invention;

FIG. 3 is a schematic view of the foam sheets after foaming according to the method of the present invention; and

FIG. 4 is a photo of the actual product of the foam mat manufactured by the method of the present invention.

### DETAILED DESCRIPTION OF THE PREFERRED EMBODIMENTS

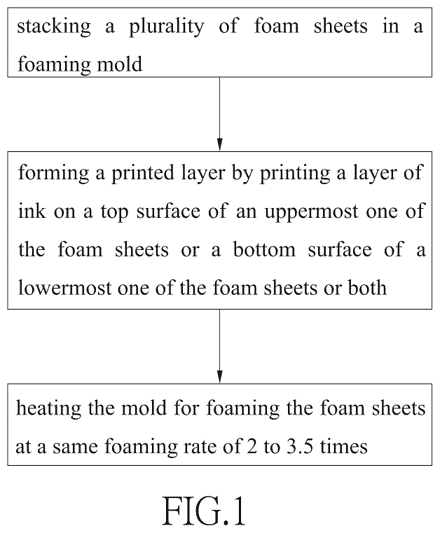

Referring to FIG. 1, a method for manufacturing a foam mat having a printed layer on its surface according to the present invention comprises the steps of:
stacking a plurality of foam sheets in a foaming mold;
forming a printed layer by printing a layer of ink on the top surface of the uppermost one of the foam sheets or the bottom surface of the lowermost one of the foam sheets or both; and
heating the mold for foaming the foam sheets at a same foaming rate of 2 to 3.5 times.

In this embodiment, the foam sheets are made of rubber or a mixed material mainly consisting of rubber, so that the finished foam mat is light in weight and easy to carry. The foam sheets may use virgin or recycled materials. The virgin material has a lighter color, and the recycled material has a darker color. When printing, according to the color of the foam sheets to select the ink of similar color, the color of the printed layer will not be affected or disturbed too much by the color of the foam sheets. In addition, the printed layer may be formed with a pattern.

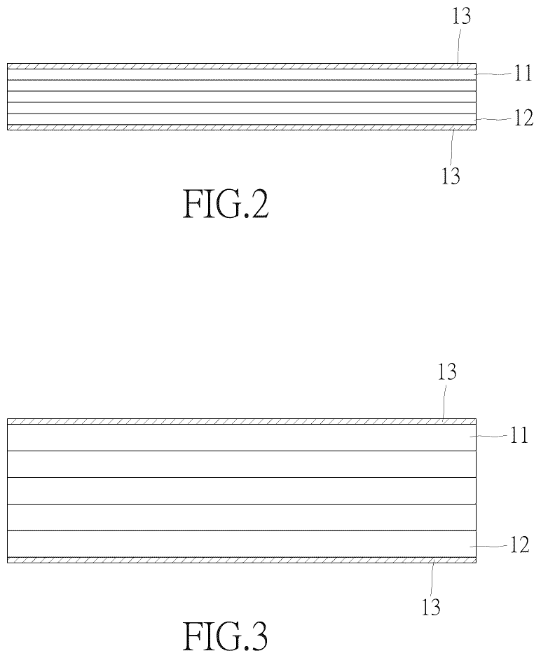

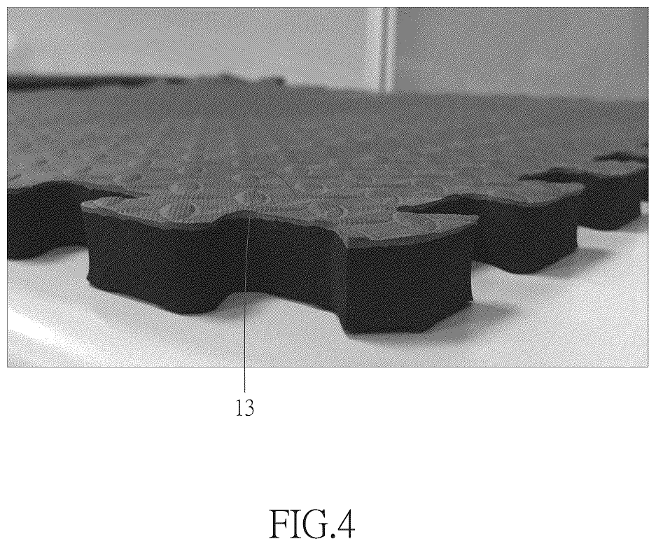

As shown in FIG. 2 and FIG. 3, the printed layer 13 may be printed on the top surface of the uppermost foam sheet 11 or the bottom surface of the lowermost foam sheet 12 according to the design requirements. According to the selected printing position, the top surface or the bottom surface, or the top and bottom surfaces of the finished foam mat present the color or pattern of the printed layer 13, as shown in FIG. 4.

Because the ink is printed on the foam sheet before foaming and the expansion after foaming will change the appearance of the printed layer, the preferred foaming ratio is between 2 and 3.5 times, such that the appearance of the printed layer can be controlled without excessive changes, so as to maintain the aesthetics of the design.

Except for the uppermost foam sheet or the lowermost foam sheet on which the printed layer is printed, the number of the other foam sheets depends on the design thickness of the foam mat. In the present invention, each of the foam sheets is foamed at the same foaming rate, and the number of stacked foam sheets in the mold determines the thickness of the finished foam mat.

Through the method provided by the present invention, the ink is printed on the foam sheet before foaming, so that the printed layer is firmly attached to the surface of the foam mat after the foaming is completed, and will not fall off, so as to maintain the beauty of the surface of the foam mat. The printed layer also fills the pores on the surface of the foam mat, so that the surface of the foam mat is flat. Dust or dirt will not be accumulated in the foam mat. The foam mat can be maintained in a hygienic condition for use.

1. A method for manufacturing a foam mat having a printed layer on its surface, comprising the steps of:
stacking a plurality of foam sheets in a foaming mold;
forming a printed layer by printing a layer of ink on a top surface of an uppermost one of the plurality of foam sheets or a bottom surface of a lowermost one of the plurality of foam sheets or both; and
subsequent to the forming of said printed layer, heating the mold for foaming the plurality of foam sheets at a same foaming rate to an expansion ratio ranging between 2 and 3.5 times.

2. The method as claimed in claim 1, wherein the plurality of foam sheets are made of rubber.

3. The method as claimed in claim 1, wherein the plurality of foam sheets are made of a mixed material mainly consisting of rubber.

4. The method as claimed in claim 1, wherein the printed layer has a single color.

5. The method as claimed in claim 1, wherein the printed layer has a pattern.

6. The method as claimed in claim 1, wherein the plurality of foam sheets have a shade similar to that of the printed layer.
